(19) United States
(12) Patent Application Publication
(10) Pub. No.: US 2026/0238929 A1
(43) Pub. Date: Aug. 13, 2026

(54) ELECTROACOUSTIC TRANSDUCER AND HEADPHONE

(71) Applicant: Audio-Technica Corporation, Tokyo (JP)

(72) Inventors: Kouhei YOSHIDA, Tokyo (JP); Akihito TAMAMURA, Tokyo (JP)

(21) Appl. No.: 19/471,201

(22) PCT Filed: Apr. 4, 2024
(86) PCT No.: PCT/JP2024/013968

§ 371 Date: Sep. 30, 2025

(30) Foreign Application Priority Data
Apr. 7, 2023 (JP) 2023-063056

(51) Int. Cl. H04R 11/02; H04R 1/10

(52) U.S. Cl. CPC H04R 11/02; H04R 1/10; H04R 2460/13

(57) ABSTRACT

Provided is an electroacoustic transducer capable of maintaining stable performance.

An electroacoustic transducer 1 that transmits vibration to a bone includes a main frame 10 having at least a cylindrical portion, a vibration unit 30 disposed inside the main frame and configured to vibrate along an axial direction of the main frame in response to an input signal, and an elastic member 20 connected to at least the vibration unit and formed of an organic substance or a polymer material.

### TECHNICAL FIELD

The present invention relates to an electroacoustic transducer that performs bone conduction and a headphone.

### BACKGROUND ART

There has been known a sound output device that hears air conduction sound generated from a skull or the like into an ear canal via bone conduction by bringing an outer wall surface into contact with the skull or the bone around the entrance of the ear canal.

Hitherto, for example, a bone conduction vibration source device for a mobile phone or the like, which performs acoustic processing on a sound signal for bone conduction vibration and outputs a processed signal as a drive signal to a bone conduction vibration source, has been known (see, for example, Patent Literature 1). In addition, a stereo earphone having a bone conduction portion and a branch portion connected to the bone conduction portion at one end and serving as a vibration source is disclosed (see, for example, Patent Literature 2).

A sound output device using bone conduction includes a vibration unit that vibrates in response to a sound signal. In this vibration unit, there is a possibility that wild vibration at a resonance point, that is, vibration in an unintended direction, and an abnormal sound accompanying the vibration occur.

### CITATION LIST

### Patent Literature

Patent Literature 1: JP 2013-197730 A

Patent Literature 2: JP 2014-116755 A

### SUMMARY OF INVENTION

### Technical Problem An object of the present invention is to provide an electroacoustic transducer and a headphone capable of maintaining stable performance.

### Solution to Problem

An electroacoustic transducer according to the present invention is an electroacoustic transducer that transmits vibration to a bone, the electroacoustic transducer including: a main frame including at. least a cylindrical portion; a vibration unit disposed inside the main frame and configured to vibrate along an axial direction of the main frame in response to an input signal; and an elastic member connected to at least the vibration unit and formed of an organic substance or a polymer material.

Further, a headphone according to another aspect of the present invention includes: a headband; and a pair of electroacoustic transducers held at both ends of the headband, respectively, wherein each of the electroacoustic transducers is the above-described electroacoustic transducer.

### Advantageous Effects of Invention

According to the present invention, it is possible to provide an electroacoustic transducer and a headphone capable of maintaining stable performance.

### BRIEF DESCRIPTION OF DRAWINGS

FIG. 1 is a schematic perspective view illustrating a headphone according to an embodiment of the present invention. FIG. 2(a) is a front perspective view of an electroacoustic transducer according to a first embodiment of the present invention, and FIG. 2(b) is an exploded perspective view of the electroacoustic transducer.

FIG. 3 is a longitudinal sectional view of the electroacoustic transducer.

FIG. 4(a) is a front perspective view of an electroacoustic transducer according to a second embodiment of. the present invention, and FIG. 4(b) is an exploded perspective view of the electroacoustic transducer.

FIG. 5 is a longitudinal sectional view of the electroacoustic transducer.

FIG. 6(a) is a front perspective view of an electroacoustic transducer according to a third embodiment of the present invention, and FIG. 6(b) is an exploded perspective view of the electroacoustic transducer.

FIG. 7 is a longitudinal sectional view of the electroacoustic transducer.

FIG. 8(a) is a front perspective view of an electroacoustic transducer according to a fourth embodiment of the present invention, and FIG. 8(b) is an exploded perspective view of the electroacoustic transducer.

FIG. 9 is a longitudinal sectional view of the electroacoustic transducer.

FIG. 10(a) is front perspective view of an electroacoustic transducer according to a fifth embodiment of the present invention, and FIG. 10(b) is an exploded perspective view of the electroacoustic transducer.

FIG. 11(a) is a longitudinal sectional view of the electroacoustic transducer, and FIG. 11(b) is a transverse sectional view of the electroacoustic transducer.

FIG. 12(a) is a front perspective view of an electroacoustic transducer according to a sixth embodiment of the present invention, and FIG. 12(b) is an exploded perspective view of the electroacoustic transducer.

FIG. 13(a) is a longitudinal sectional view of the electroacoustic transducer, and FIG. 13(b) is a transverse sectional view of the electroacoustic transducer.

FIG. 14(a) is front perspective view of an electroacoustic transducer according to a seventh embodiment of the present invention, and FIG. 14(b) is an exploded perspective view of the electroacoustic transducer.

FIG. 15(a) is a longitudinal sectional view of the electroacoustic transducer, and FIG. 15(b) is a transverse sectional view of the electroacoustic transducer.

FIG. 16 is a longitudinal sectional view illustrating an electroacoustic transducer according to an eighth embodiment of the present invention.

FIG. 17 is a longitudinal sectional view illustrating an electroacoustic transducer according to a ninth embodiment of the present invention.

FIG. 18 is a graph illustrating frequency characteristics of the above-described electroacoustic transducer and an electroacoustic transducer according to a related art.

FIG. 19 is a longitudinal sectional view illustrating a first example of the electroacoustic transducer according to the related art.

FIG. 20 is a longitudinal sectional view illustrating a second example of the electroacoustic transducer according to the related art.

### DESCRIPTION OF EMBODIMENTS

Hereinafter, embodiments of electroacoustic transducers according to the present invention will be described with reference to the drawings. In the following description, the axial direction of the electroacoustic transducer 1 will also be referred to as a Y direction, and the directions orthogonal to the Y direction will also be referred to as an X direction and a Z direction. A surface facing the +Y direction will also be referred to as an upper surface, and a surface facing the −Y direction will also be referred to as a lower surface. Further, a surface facing the −X direction will also be referred to as a front surface, and a surface facing the +X direction will also be referred to as a back surface.

### Headphone

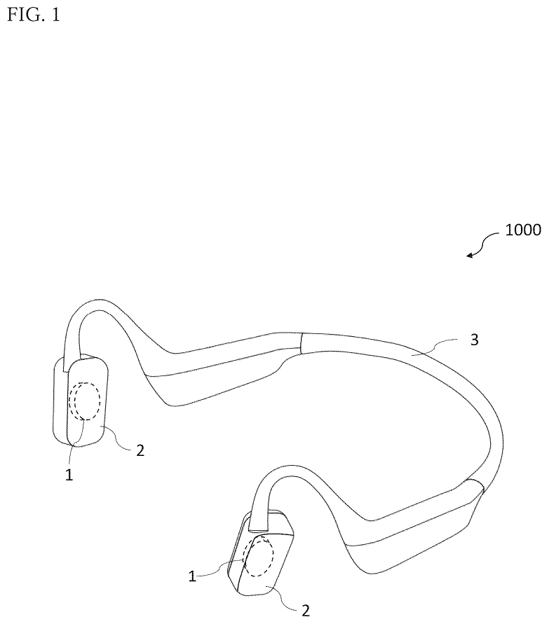

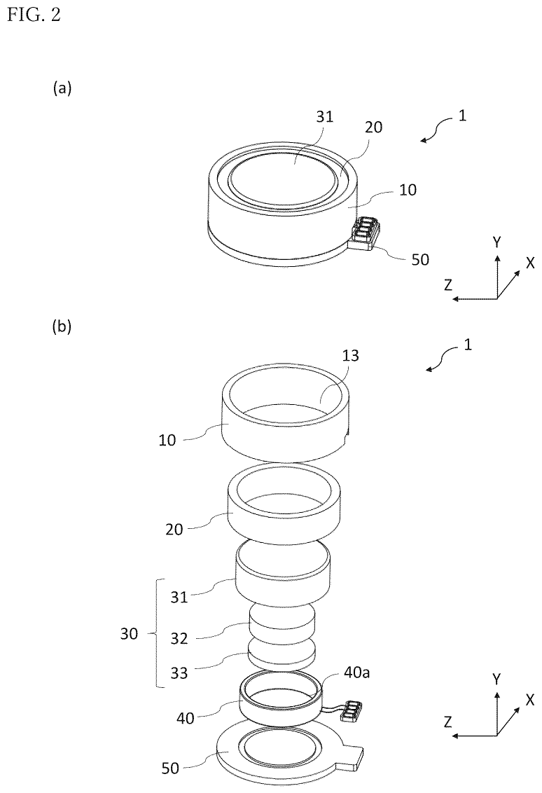

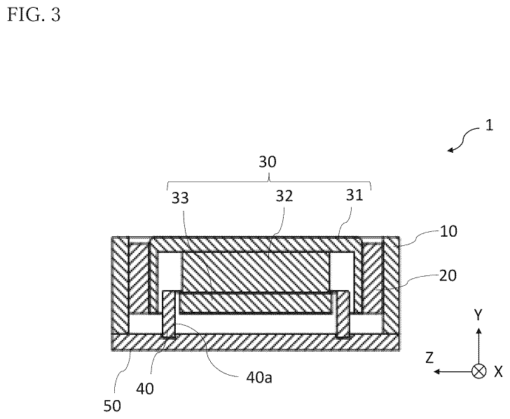

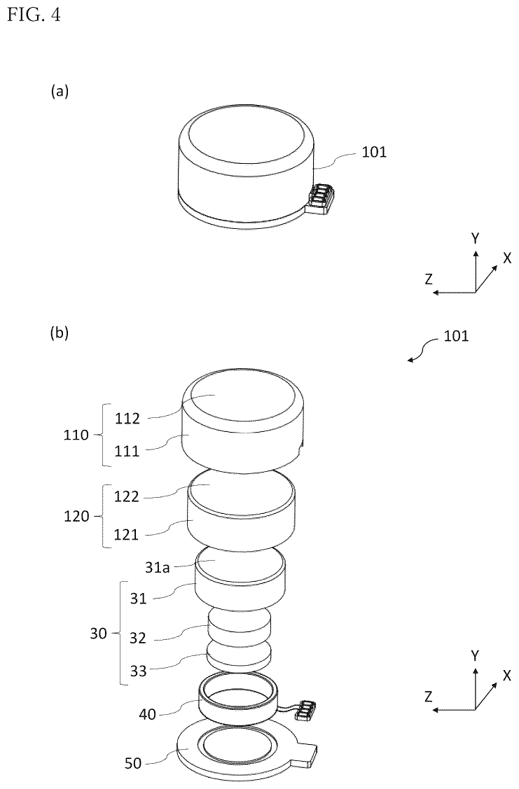

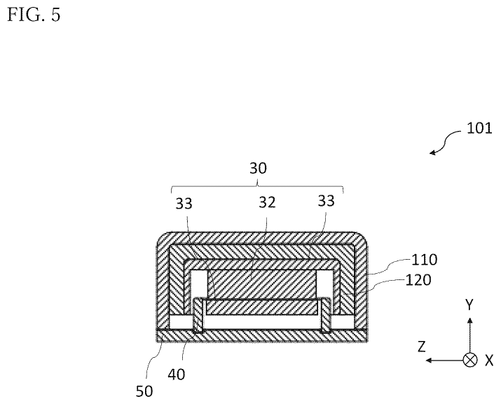

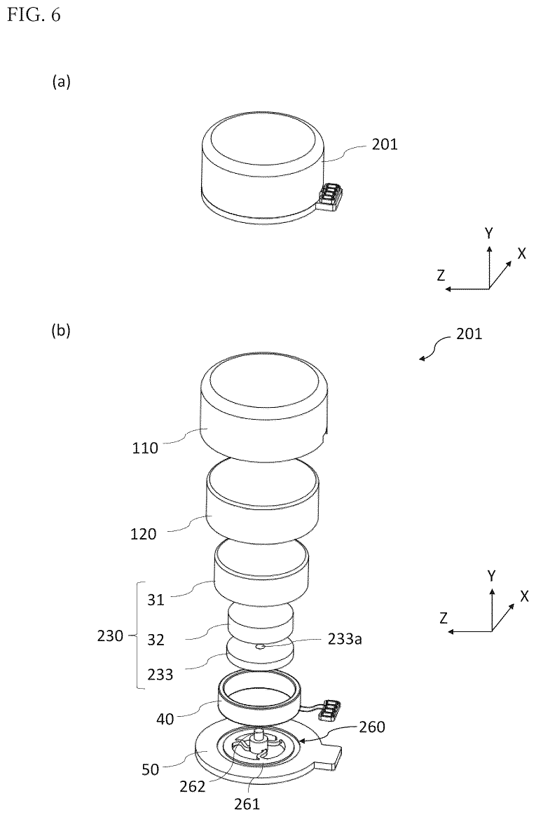

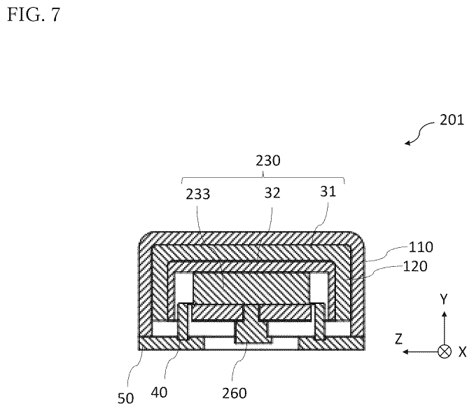

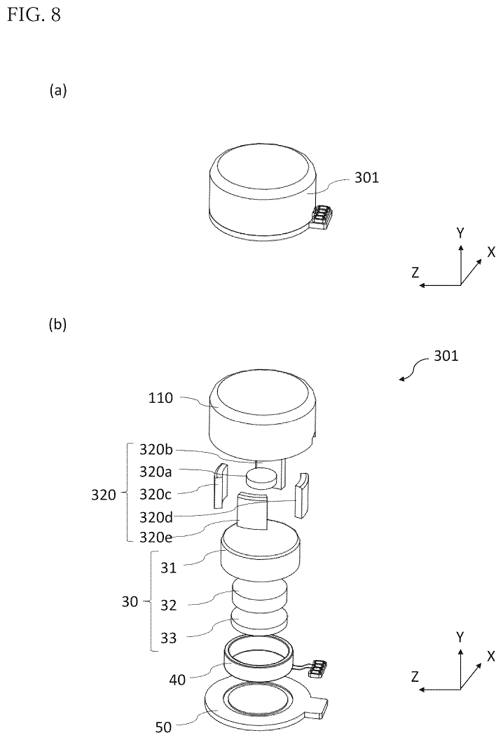

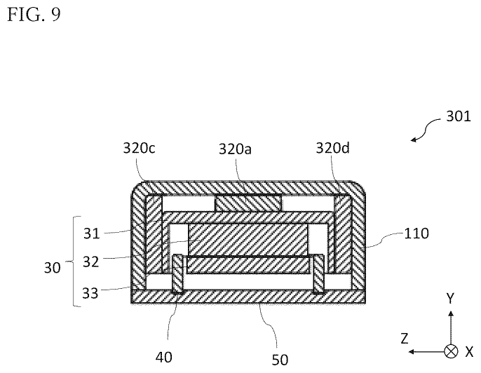

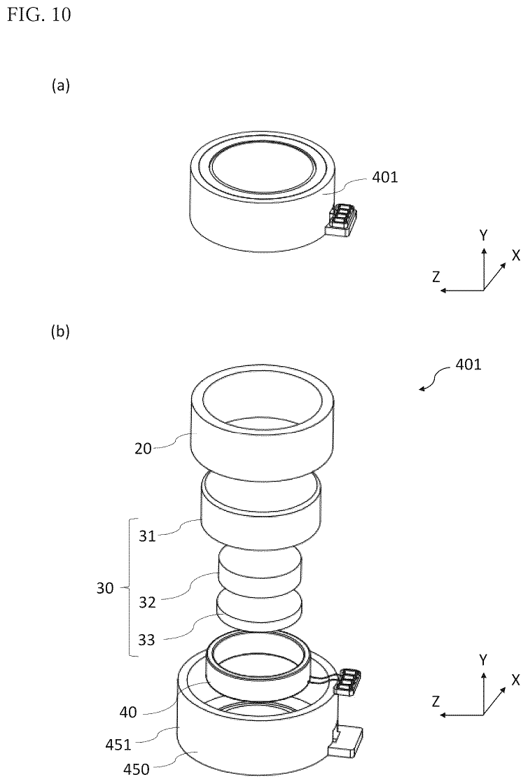

As illustrated in FIG. 1, a headphone 1000 mainly includes a pair of electroacoustic transducers 1, a pair of housings 2, and a headband 3. Each of the pair of housings 2 has a substantially rectangular parallelepiped shape, and houses the electroacoustic transducer 1 therein. The headband 3 is a substantially U-shaped member. Both end portions of the headband 3 are curved in a direction substantially orthogonal to a U-shaped portion so as to be hung on the wearer's ears in the worn state. The housings 2 are connected to both end portions of the headband 3, respectively. That is, the electroacoustic transducers 1 are held at both end portions of the headband 3 via the housings 2. The headband 3 holds the wearer's head in the worn state, and the housings 2 are pressed against the wearer's ears by the elastic force of the headband 3.

Note that, in the present embodiment, a configuration in which the electroacoustic transducer transmits vibration mainly to the ear cartilage will be described, but the technical scope of the present invention is not limited thereto, and covers a headphone and an electroacoustic transducer that transmit vibration to any bone including cartilage other than the ear cartilage and hard bones such as the skull.

### Electroacoustic Transducer (1)

First, a first embodiment of an electroacoustic transducer of the present embodiment will be described. The electroacoustic transducer 1 is, for example, a headphone unit.

As illustrated in FIGS. 2(a) and 2(b), the electroacoustic transducer 1 is a substantially cylindrical member that is worn to each of the left and right ears in a pair. The electroacoustic transducer 1 mainly includes a main frame 10, an elastic member 20, a vibration unit 30, a coil 40, and a unit base 50.

The main frame 10 is a member having a cylindrical portion that defines an outer wall of the electroacoustic transducer 1. Although the main frame 10 has a substantially cylindrical shape in the present embodiment, any appropriate structure such as an elliptical cylindrical shape or a rectangular cylindrical shape can be adopted.

The elastic member 20 is a cylindrical member disposed inside the main frame 10, In the present embodiment, the elastic member 20 is disposed in the circumferential direction of the vibration unit 30. The elastic member 20 is a member formed of an organic substance or a polymer material having elasticity. The elastic member 20 is, for example, a member that exerts elasticity by a porous structure, and more specifically, is, for example, urethane foam. In addition, the elastic member 20 may be formed of an appropriate sponge material. Furthermore, the elastic member 20 may be made of an elastic body such as rubber or a gel material.

The elastic member 20 holds the vibration unit 30 on the main frame 10. The elastic member 20 is connected to the outer peripheral surface along the vibration direction of the vibration unit 30 and the inner peripheral surface of the main frame 10. For example, the elastic member 20 may be bonded to the outer peripheral surface of the vibration unit 30 and the inner peripheral surface of the main frame 10 with an appropriate adhesive. As a result, the elastic member 20 controls the vibration of the vibration unit 30.

The vibration unit 30 is a member disposed inside a through hole 13 of the main frame 10. The vibration unit 30 vibrates inside the through hole 13 along the axial direction of the through hole 13 in response to a signal.

As illustrated in FIG. 2(b), the vibration unit 30 mainly includes a cap yoke 31, a magnet 32, and a center yoke 33.

The cap yoke 31 is a bottomed cylindrical member constituting an upper surface and a side surface of vibration unit 30. An end portion on the upper surface side (+Y side) of the cap yoke 31 is exposed to the upper surface (+Y side) of the electroacoustic transducer 1. As illustrated in FIG. 3, the lower end of the cap yoke 31 on the −Y side faces the unit base 50 with a gap therebetween. The inner diameter of the cap yoke 31 is larger than the outer diameter of the coil 40. As a result, the cap yoke 31 covers a part of the outer periphery of the coil 40. The elastic member 20 is connected to the outer peripheral surface of the cap yoke 31.

The magnet 32 is a substantially cylindrical magnet, and is disposed inside the cap yoke 31. The magnet 32 may be connected to the inner bottom surface of the cap yoke 31. The center yoke 33 is a disk-shaped member connected to the lower end of the magnet 32. The outer diameter of the magnet 32 is smaller than an inner diameter of a hole 40a of the coil 40. Therefore, the magnet 32 and the center yoke 33 are movable in the axial direction (y direction) inside the hole 40a. A Lorentz force is generated between the magnet 32 and the coil 40. As a result, the vibration unit 30 vibrates in the axial direction.

The coil 40 is an annular member, and is held by the unit base 50. The magnet 32 and the center yoke 33 are inserted through the hole 40a formed at the center of the coil 40.

As described above, the vibration direction in which the vibration unit 30 vibrates in response to the signal is the Y direction, which is different from the vertical direction in the worn state. That is, the vibration unit 30 receives gravity in a direction different from the vibration direction. The elastic member 20 supports the vibration unit 30 by connecting the elastic member 20 to the main frame 10 and the vibration unit 30. That is, the elastic member 20 is capable of preventing the vibration unit 30 from sagging due to gravity.

The elastic member 20 has a predetermined hardness and a predetermined restitution coefficient. As a result, the elastic member 20 damps and eliminates abnormal oscillation at the resonance point of the vibration unit 30, and also suppresses displacement of the vibration unit 30 in a direction different from the vibration direction. In addition, the elastic member 20 is connected along the circumferential direction of the vibration unit 30, thereby suppressing displacement of the vibration unit 30 in the rotation direction. The displacement of the vibration unit 30 in a direction other than the vibration direction in which the vibration unit vibrates in response to the signal causes abnormal noise. In contrast, the elastic member 20 can prevent displacement in a direction other than the axial direction, thereby suppressing abnormal noise, and as a result, improving the sound quality of the electroacoustic transducer 1. The characteristics of the elastic member 20, such as hardness or restitution coefficient, are appropriately adjusted according to the desired sound quality, the mass of shape of the vibration unit 30, and the like.

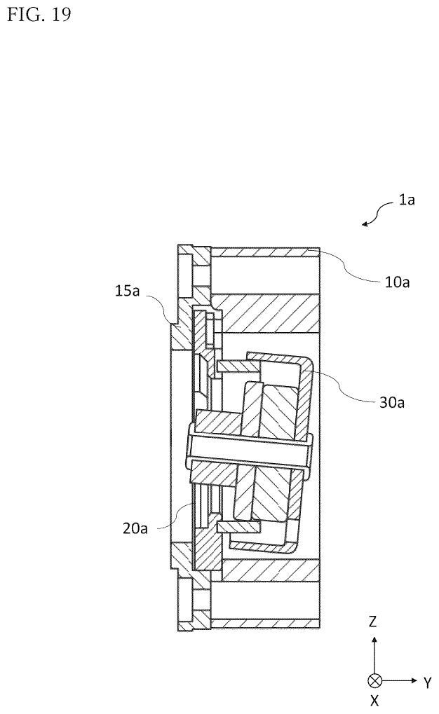

Here, an electroacoustic transducer la according to a related art will be described with reference to FIG. 19.

The electroacoustic transducer la illustrated in FIG. 19 mainly includes a cylindrical main frame 10a, a disk-shaped suspension 20a, and a vibration unit 30a that vibrates inside the main frame 10a.

The suspension 20a is in contact with an inner side of a flange portion 15a formed on an inner wall of the main frame 10a. Further, the center portion of the vibration unit 30a is connected to the center of the suspension 20a by a connecting member such as a screw. As a result, the vibration unit 30a is supported by the flange portion 15a via the suspension 20a. Therefore, the fulcrum of vibration of the vibration unit 30a serves as a connecting member, and the contact portion between the suspension 20a and the flange portion 15a serves as an action point. In this manner, the electroacoustic transducer 1a, in which the center of gravity and the fulcrum of vibration of the vibration unit 30a are separated from each other, may vibrate wildly at the resonance point, that is, vibrate in an unintended direction. The wild vibration at the resonance point causes abnormal noise.

In addition, in FIG. 19, the vertical direction in the worn state is a downward direction on the paper. The vibration direction in which the vibration unit 30a vibrates in response to the signal is different from the vertical direction in the worn state. Therefore, gravity is applied to the vibration unit 30a in a direction different from the vibration direction, A first end side of the vibration unit 30a is connected to the suspension 20a at a substantially central portion, while a second end side of the vibration unit 30a is not supported and is in a cantilever state. Therefore, the second end of the vibration unit 30a sags in the direction of gravity. As a result, an unnecessary moment or twist occurs in the electroacoustic transducer la at the time of resonance. This moment or twist causes wild vibration or breakage,

Furthermore, the mass of the vibration unit 30a in the electroacoustic transducer la that transmits vibration to the ear cartilage is larger than that of a headphone unit that vibrates a diaphragm in order to vibrate the ear cartilage. Therefore, the sagging or the wild vibration at the resonance point of the vibration unit 30a is greater than that of the headphone unit including the diaphragm. As a result, the sagging or the wild vibration causes a failure.

Furthermore, the vibration unit 30a of the electroacoustic transducer la may vibrate due to external vibration. In this case, when the vibration unit 30a vibrates, an electromotive force is generated in a coil 140 disposed opposite to the vibration unit 30a. As a result, in the headphone unit including the vibration unit, the vibration may cause abnormal noise that may be mixed into a sound.

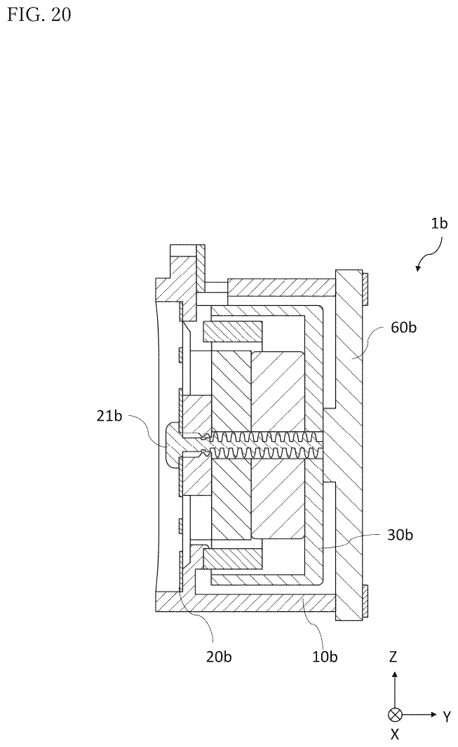

In addition, an electroacoustic transducer 2b according to a related art illustrated in FIG. 20 mainly includes a cylindrical main frame 10b, a vibration unit 30b that vibrates inside the main frame 10b, a disk-shaped suspension 20b that holds the vibration unit 30b on a first end side of the main frame 10b, and a flat plate-shaped damper 60b that holds the vibration unit 30b on a second end side of the main frame 10b. The suspension 20b is formed of, for example, a metal leaf spring.

The vibration unit 30b is held at the first end and the second end of the main frame 10b via the damper 60b. Therefore, the electroacoustic transducer 1b is less likely to fail because unintended vibration of the vibration unit 30 is suppressed. In addition, since the elastic member 20 and the damper 60b, each having elasticity, are interposed between the vibration unit 30b and the main frame 10b, the amplitude (Q value) at the resonance point is effectively controlled, As a result, even in a configuration using cartilage conduction in which the mass of the vibration unit 30b is larger than that of a headphone unit including a diaphragm, it is possible to realize the electroacoustic transducer 1b with high sound quality while suppressing unintended vibration,

On the other hand, since the suspension 20b of the electroacoustic transducer 2b according to the related art is a metal leaf spring, there is a risk of plastic deformation. In addition, the influence of resonance may be large and the cost may be high.

In this respect, the electroacoustic transducer 1 according to the present invention includes an elastic member 20 formed of an organic substance or a polymer material having a predetermined or higher level of elasticity, instead of the elastic member that exerts elasticity by its metal or resin structure. Therefore, the electroacoustic transducer 1 according to the present invention reduces the risk of plastic deformation of the elastic member 20. In addition, the electroacoustic transducer 1 according to the present invention can reduce the influence of resonance, and can be made in an inexpensive manner.

### Frequency Response Characteristics

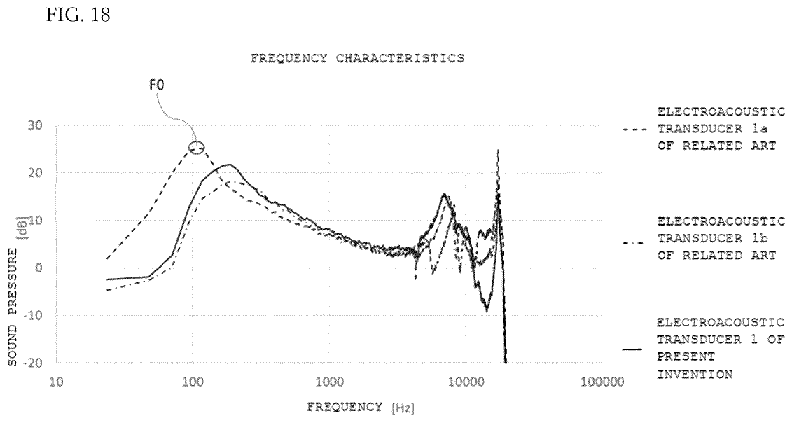

FIG. 18 illustrates frequency characteristics of headphone units. That is, the horizontal axis represents a frequency, and the vertical axis represents an output level (dBV). A broken line indicates a frequency characteristic of the electroacoustic transducer la according to the related art, a one-dot chain line indicates a frequency characteristic of the electroacoustic transducer 1b according to the related art, and a solid line indicates a frequency characteristic of the electroacoustic transducer 1 according to the present invention.

The electroacoustic transducer 1a according to the related art has a resonance point F0. The frequency at the resonance point F0 is determined by the relationship between the spring constant of the suspension 20a and the weight of the vibration unit 30a. As a result, the electroacoustic transducer 1a may give discomfort to the wearer's head due to very large vibration generated at the frequency of the resonance point F0.

The frequency characteristic of the electroacoustic transducer 1b according to the related art is smoother than the frequency characteristic of the electroacoustic transducer 1a, because low-frequency resonance is damped by the damper 60b. That is, the electroacoustic transducer 1b can suppress unintended resonance and reduce discomfort given to the head.

The frequency characteristic of the electroacoustic transducer 1 according to the present invention is smooth with a low peak, similarly to the frequency characteristic of the electroacoustic transducer 1b according to the related art. In addition, the frequency at the peak is higher than that at the resonance point F0 of the electroacoustic transducer 1a. Therefore, it can be said that the damping effect provided by the elastic member 20 is sufficiently functioning. In addition, in the frequency characteristic of the electroacoustic transducer 1 according to the present invention, the sensitivity is also sufficiently high, and it can be seen that a sound pressure equal to or higher than that of the electroacoustic transducer la can be realized in a wide band.

### Electroacoustic Transducer (2)

Here, different embodiments of electroacoustic transducers according to the present embodiment will be described, focusing on differences from the embodiment described above. The same components as those in the first embodiment are denoted by the same reference signs. In addition, the electroacoustic transducers to be described below have the same configuration as the electroacoustic transducer 1 unless otherwise specified.

An electroacoustic transducer 101 according to a second embodiment illustrated in FIGS. 4 and 5 is different from the first embodiment in that a main frame 110 and an elastic member 120 are bottomed cylindrical bodies in which bottom portions 112 and 122 are connected to cylindrical portions 111 and 121, respectively. A surface of the vibration unit 30 facing the vibration direction, that is, an outer wall surface 31a of the cap yoke 31, faces the bottom portion 112 of the main frame 110 via the elastic member 120. The cylindrical portion 121 of the elastic member 120 is connected to the cylindrical portion 111 of the main frame 10, and the bottom portion 122 of the elastic member 120 is connected to the bottom portion 112 of the main frame 10. According to such a configuration, positioning in the axial direction (Y direction) is easy, resulting in high productivity. In addition, the vibration unit 30 is not exposed, making it possible to reduce the risk of breakage. Note that an appropriate opening may be formed in the elastic member 120. Further, a slit may be formed in the elastic member 120. According to such a configuration, the flexibility of the elastic member 120 can be improved.

### Electroacoustic Transducer (3)

An electroacoustic transducer 201 according to a third embodiment illustrated in FIGS. 6 and 7 includes a suspension 260 in addition to the electroacoustic transducer 101 according to the second embodiment. The suspension 260 is a member having a disk portion 261 having a substantially circular shape with a protruding portion 262 at the center thereof. In addition, a plurality of holes are formed in the disk portion 261, which serves as a spring that exerts elasticity in the Y direction, The radial end of the disk portion 261 is locked to one end of the main frame 10. In a vibration unit 230 included in the electroacoustic transducer 201, a hole 233a formed along the axial direction of the main frame 10 is provided substantially at the center of the center yoke 233, The suspension 260 is connected to the vibration unit 230 by inserting the protruding portion 262 through the hole 233a. As a result, the suspension 260 restricts the position of the vibration unit 230, and limits the vibration of the vibration unit 230 in the Y direction, According to such a configuration, the position of the vibration unit 230 is determined by the suspension 260, making assembly easy.

### Electroacoustic Transducer (4)

An electroacoustic transducer 301 according to a fourth embodiment illustrated in FIGS. 8 and 9 is different from the embodiment described above in that plurality of elastic members 320 are provided. The elastic members 320 include a small member 320a disposed on the bottom surface of the cap yoke 31 and small members 320b, 320c, 320d, and 320e disposed with gaps therebetween along the circumferential direction of the cap yoke 31. The number of small members 320b to 320e is four in the present embodiment, but the number is not limited thereto. Note that appropriate coupling members for coupling the small members 320a to 320e may be provided. For the elastic members 320, a gel material, which is a relatively hard member, is suitably adopted. According to such a configuration, the contact area of the elastic members 320 is smaller than that of the elastic member 120, which is a bottomed cylindrical body, and the vibration unit 30 can be vibrated more greatly.

### Electroacoustic Transducer (5)

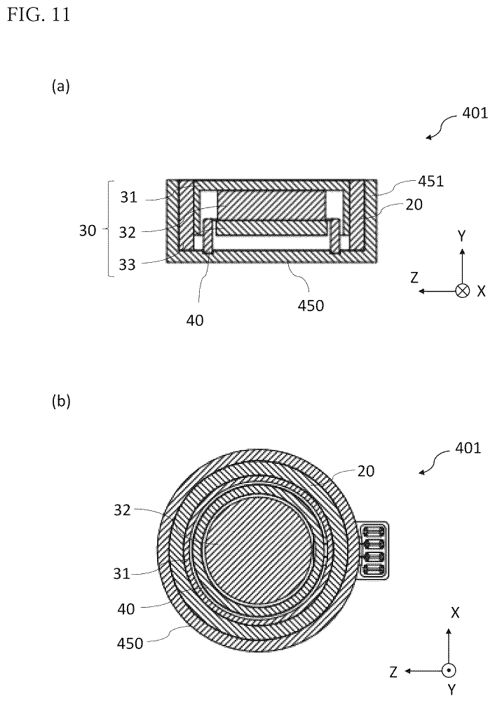

An electroacoustic transducer 401 according to a fifth embodiment illustrated in FIGS. 10 and 11 includes a unit base 450 having a bottomed cylindrical shape. The unit base 450 has a side wall 451 extending so as to cover a side surface of the vibration unit 30. The elastic member 20 is connected to the inner peripheral surface of the side wall 451. In addition, the elastic member 20 is connected to the cap yoke 31 constituting the outer periphery of the vibration unit 30. According to such a configuration, the side wall 451 of the unit base 450 corresponds to the cylindrical portion of the main frame, and a separate member is unnecessary, thereby simplifying the configuration.

### Electroacoustic Transducer (6)

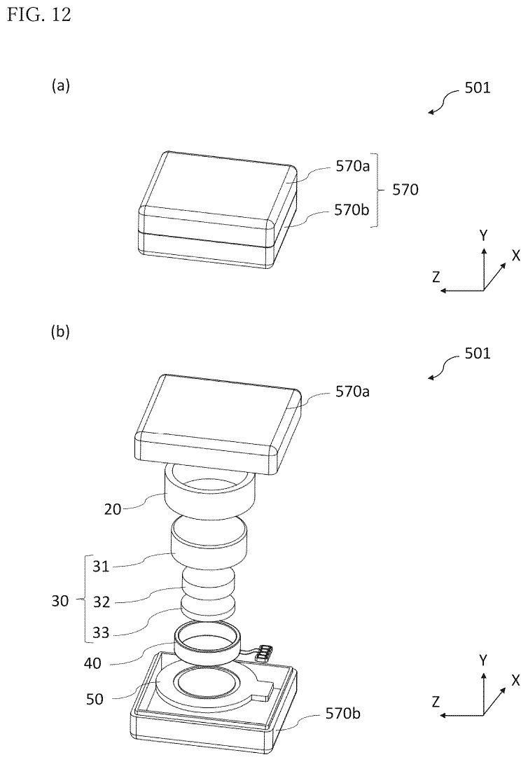

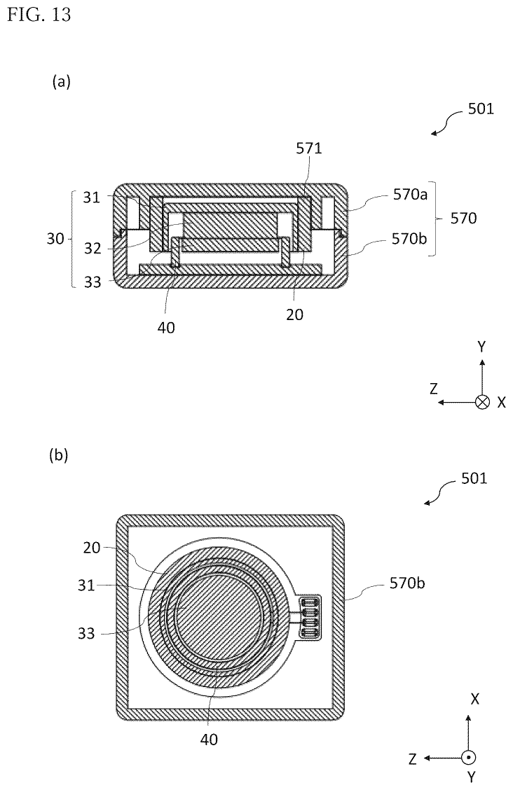

An electroacoustic transducer 501 according to a sixth embodiment illustrated in FIGS. 12 and 13 includes a housing 570 that accommodates a vibration unit 30. The housing 570 accommodates the elastic member 20, the vibration unit 30, the coil 40, and the unit base 50, for example, by fitting an upper housing 570a and a lower housing 570b to each other. The shape of the housing 570 is a substantially rectangular parallelepiped in the drawings, but is not limited thereto, and an appropriate shape that matches the outer shape of the headphone 1000 can be adopted.

As illustrated in FIG. 13(a), a protruding rib 571 is formed inside the upper housing 570a. The rib 571 has, for example, a tubular shape corresponding to the elastic member 20, but is not limited thereto, and may be constituted by, for example, a plurality of protrusions. The elastic member 20 is connected to the inside of the rib 571. For example, the elastic member 20 may be bonded to the rib 571. According to such a configuration as well, the rib 571 of the upper housing 570a corresponds to the cylindrical portion of the main frame, and a separate member is unnecessary, thereby simplifying the configuration.

### Electroacoustic Transducer (7)

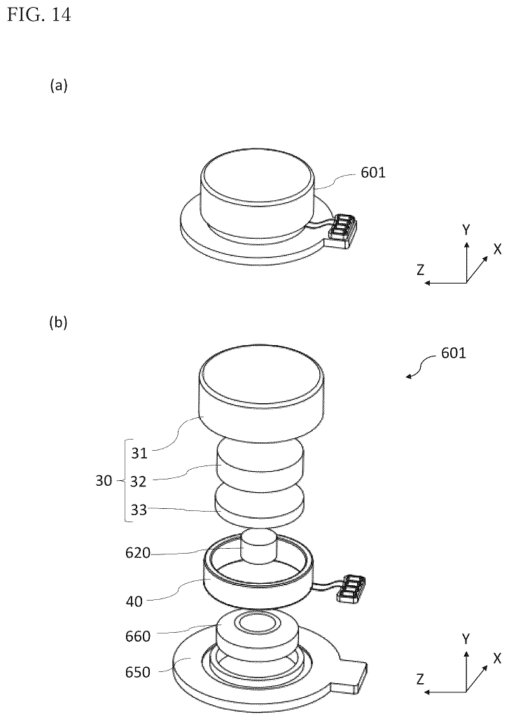

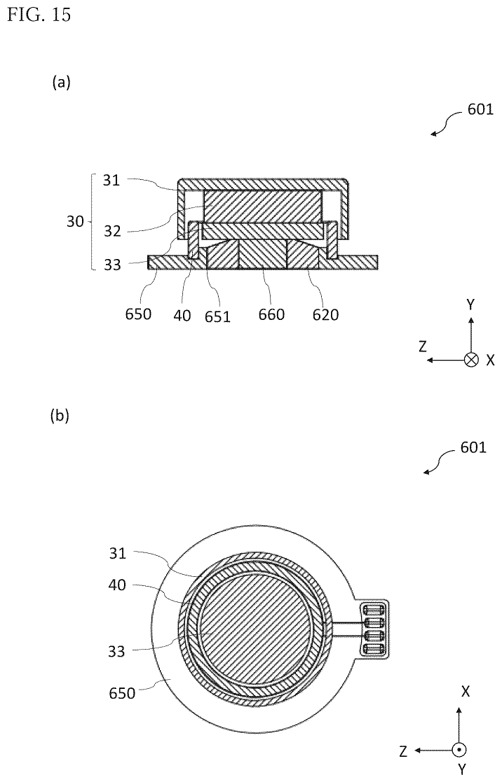

An electroacoustic transducer 601 according to a seventh embodiment illustrated in FIGS. 14 and 15 is different from the embodiment described above in that a cylindrical elastic member 620 and a shaft member 660 inserted through the elastic member 620 are disposed at an end portion in the vibration direction of the vibration unit 30. The radius of the elastic member 620 is smaller than the inner diameter of the coil 40. The elastic member 620 and the shaft member 660 are connected to a surface of the center yoke 33 facing the vibration direction on the radially inner side of the main frame 10 and the coil 40. In addition, the elastic member 620 is fitted into a hole 651 formed in the unit base 650. For the elastic member 620, a material that is relatively harder than the elastic member 20 described above is suitably adopted. According to such a configuration as well, the vibration of the vibration unit 30 in the direction can be limited. In addition, according to such a configuration, the electroacoustic transducer 601 can be configured with a small number of parts.

### Electroacoustic Transducer (8)

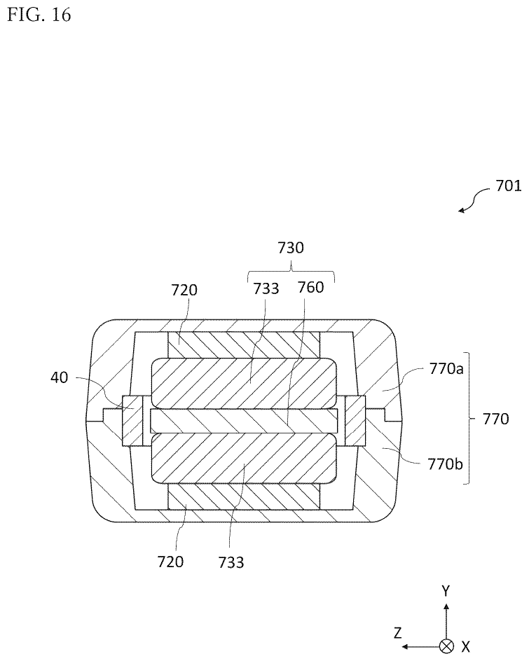

An electroacoustic transducer 701 according to an eighth embodiment illustrated in FIG. 16 is different from the embodiment described above in that elastic members 720 are disposed in front of and behind a vibration unit 730 in the vibration direction. The electroacoustic transducer 701 includes a housing 770 that accommodates the vibration unit 730 therein. The housing 770 includes, for example, an upper housing 770a constituting an upper portion in the drawing of the housing 770 and a lower housing 770b constituting a lower portion in the drawing of the housing 770. The housing 770 is another example of the main frame.

The coil 40, the vibration unit 730 inserted through the coil, and the elastic members 720 are mainly accommodated inside the housing 770. The coil 40 is fixed to the inside of the housing 770. The vibration unit 730 includes, for example, a magnet 733 and a center yoke 760. The vibration unit 730 has a configuration in which, for example, two magnets 733 sandwich the center yoke 760 therebetween. In this case, the two magnets 733 sandwich the center yoke 760 with the same poles, that is, S poles or N poles facing each other. According to such a. configuration, sensitivity can be improved as compared with a configuration in which one magnet and one center yoke are provided.

The elastic members 720 are disposed in front of and behind the vibration unit 730 in the vibration direction. Note that the elastic member 720 may be disposed only on one of the front side and the rear side in the vibration direction. The elastic member 720 has a first end connected to the inside of the housing 770 and a second end connected to the vibration unit 730. When a current flows through the coil 40, the vibration unit 730 vibrates mainly in the up-down direction in the drawing while deforming the elastic members 720. According to such a configuration, it is possible to realize a simple structure with a small number of parts. In addition, the simple structure enables a robust configuration. In addition, the acoustic characteristics can be adjusted by selecting the material of the elastic member 720. For example, by selecting a material having small restitution coefficient, it is possible to suppress steep resonance.

### Electroacoustic Transducer (9)

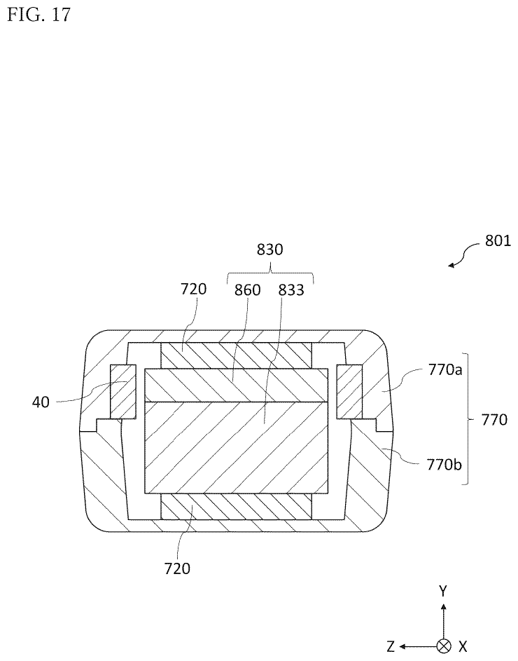

An electroacoustic transducer 801 according to a ninth embodiment illustrated in FIG. 17 is different from the embodiment described above in that the electroacoustic transducer includes vibration unit 830 configured by connecting one magnet 833 and one center yoke 860 instead of the vibration unit 730 illustrated in FIG. 16. In this case, as illustrated in the drawing, the coil 40 may be disposed near an end portion in the vibration direction of the vibration unit 830 in accordance with the position of the center yoke 860. According to such a configuration as well, it is possible to realize the electroacoustic transducer 801 with high sound quality while suppressing unintended vibration.

Also with the above-described configuration, it is possible to provide an electroacoustic transducer capable of producing high sound quality with reduced abnormal noise while having a configuration for generating bone conduction vibration.

Although the present invention has been described above using embodiments, the technical scope of the present invention is not limited to the scope described above in the embodiments, and various modifications and changes can be made within the scope of the gist of the present invention.

### REFERENCE SIGNS LIST

1 Electroacoustic transducer
10 Main frame
20 Elastic member
30 Vibration unit
40 Coil
50 Unit base
1000 Headphone

1. An electroacoustic transducer for transmitting
vibration to a bone, the electroacoustic transducer comprising:
a main frame including at least a cylindrical portion;
a vibration unit disposed inside the main frame and configured to vibrate along an axial direction of the main frame in response to an input signal; and
an elastic member connected to at least the vibration unit and formed of an organic substance or a polymer material,
wherein the elastic member is a member disposed in a circumferential direction of the vibration unit.

2. The electroacoustic transducer according to claim 1, wherein
the elastic member exerts elasticity by a porous structure.

3. The electroacoustic transducer according to claim 1, wherein
the elastic member is connected to an outer peripheral surface along a vibration direction of the vibration unit and an inner peripheral surface of the main frame.

4. The electroacoustic transducer according to claim 3, wherein
the elastic member is a cylindrical member.

5. The electroacoustic transducer according to claim 3, wherein
a plurality of the elastic members are disposed.

6. The electroacoustic transducer according to claim 1, wherein
the main frame is a bottomed cylindrical body in which a bottom portion is connected to the cylindrical portion,
a first surface facing a vibration direction of the vibration unit faces the bottom portion, and
the elastic member is connected to at least the bottom portion.

7. The electroacoustic transducer according to claim 6, wherein
the elastic member is connected to the cylindrical portion and the bottom portion of the main frame.

8. The electroacoustic transducer according to claim 1, further comprising:
a unit base that covers a second surface facing a vibration direction of the vibration unit,
wherein the unit base has a side wall extending so as to cover a side surface of the vibration unit, and
the elastic member is connected to an outer periphery of the side wall of the unit base.

9. The electroacoustic transducer according to claim 1, further comprising:
a housing that accommodates the vibration unit,
wherein the elastic member is connected to the housing.

10. The electroacoustic transducer according to claim 1, wherein
the elastic member is connected to a second surface facing a vibration direction of the vibration unit.

11. The electroacoustic transducer according to claim 1, further comprising:
a suspension locked to a first end of the main frame and configured to hold the vibration unit,
wherein the suspension includes a protruding portion inserted through the vibration unit along the axial direction of the main frame.

12. A headphone comprising:
a headband; and
a pair of electroacoustic transducers held at both ends of the headband, respectively,
wherein each of the electroacoustic transducers is for transmitting vibration to a bone, the lectroacoustic transducer comprising:
a main frame including at least a cylindrical portion;
a vibration unit disposed inside the main frame and configured to vibrate along an axial direction of the main frame in response to an input signal; and
an elastic member connected to at least the vibration unit and formed of an organic substance or a polymer material,
wherein the elastic member is a member disposed in a circumferential direction of the vibration unit.
